(19) United States
(12) Patent Application Publication
(10) Pub. No.: US 2023/0184674 A1
(43) Pub. Date: Jun. 15, 2023

(54) OPTICAL VAPE DETECTION SYSTEMS AND METHODS

(71) Applicant: Soter Technologies, LLC, Ronkonkoma, NY (US)

(72) Inventor: Cary Chu, Mount Sinai, NY (US)

(21) Appl. No.: 17/921,145

(22) PCT Filed: Jul. 13, 2021
(86) PCT No.: PCT/US2021/041391

§ 371 Date: Oct. 25, 2022

Related U.S. Application Data
(60) Provisional application No. 63/051,440, filed on Jul. 14, 2020.

(51) Int. Cl. G01N 21/39; G08B 21/12

(52) U.S. Cl. CPC G01N 21/39; G08B 21/12; G01N 2201/06113; G08B 5/36

(57) ABSTRACT

The present disclosure relates to vape detection systems and methods. In various embodiments, a vape detection system includes a light source, a detector, and a controller. The light source is configured to emit light that includes a predetermined wavelength that is absorbable by a constituent of vape. The detector is configured to detect light resulting from the emitted light. The controller is in communication with the light source and the detector and is configured to control the light source to emit the light including the predetermined wavelength, control the detector to detect light resulting from the emitted light, and determine, based on absorption spectroscopy and based on a change between the emitted light and the detected light, that the constituent of vape is present.

### CROSS-REFERENCE TO RELATED APPLICATIONS

The present application claims the benefit of and priority to U.S. Provisional Application Ser. No. 63/051,440, filed on Jul. 14, 2020, the entire content of which being incorporated herein by reference.

### FIELD

The present technology relates generally to systems and methods for identifying vaping, and more particularly, to an optical vape detector.

### BACKGROUND

Vaping has become a serious concern in enclosed areas due to hazardous/harmful effects on people. Such concerns can occur in various settings, including classrooms, restrooms, bathrooms, storage rooms, hospital rooms, or other kinds of enclosed areas in a school, hospital, warehouse, cafeteria, offices, financial institutes, governmental buildings, or any business entities. In certain settings, vaping/smoking can be identified by camera surveillance. However, such camera surveillance systems are not permitted or are not appropriate in private areas such as restrooms, bathrooms, shower rooms, or hospital rooms because privacy concerns have higher priority. Accordingly, there is interest in improving and developing vape detection technologies for various settings.

### SUMMARY

The present disclosure relates to vape detection systems and methods, including systems and methods that determine whether vape is present or absent based on optical technology.

In various embodiments, a vape detection system includes a light source, a detector, and a controller. The light source is configured to emit light where the light includes a predetermined wavelength that is absorbable by a constituent of vape. The detector is configured to detect light resulting from the emitted light. The controller is in communication with the light source and the detector and is configured to control the light source to emit the light including the predetermined wavelength, control the detector to detect light resulting from the emitted light, and determine, based on absorption spectroscopy and based on a change in intensity between the emitted light and the detected light, that the constituent of vape is present.

In various embodiments of the system, the light source is a tunable narrow band laser.

In various embodiments of the system, the detector is a photodetector.

In various embodiments of the system, the system includes a wall-mounted housing where the light source and the detector are contained in the wall-mounted housing.

In various embodiments of the system, the constituent of vape includes at least one of propylene glycol or vegetable glycerin, and the predetermined wavelength is absorbable by the propylene glycol and/or the vegetable glycerin.

In various embodiments of the system, the light source emits the light without precise temperature control and the controller controls the light source without precise temperature control.

In various embodiments of the system, the light source is configured to emit the light having a plurality of wavelengths that include the predetermined wavelength, and the plurality of wavelengths account for temperature changes due to lack of precise temperature control.

In various embodiments of the system, the detector is configured to detect a wavelength band that includes the predetermined wavelength.

In accordance with aspects of the present disclosure, a method of detecting vape includes emitting from a light source light including a predetermined wavelength that is absorbable by a constituent of vape, detecting by a detector light resulting from the emitted light, and determining, based on absorption spectroscopy and based on a change in intensity between the emitted light and the detected light, that the constituent of vape is present.

In various embodiments of the method, the light source is a tunable narrow band laser.

In various embodiments of the method, the detector is a photodetector.

In various embodiments of the method, the light source and the detector are contained in a wall-mounted housing.

In various embodiments of the method, the constituent of vape includes at least propylene glycol or vegetable glycerin, and the predetermined wavelength is absorbable by the propylene glycol and/or the vegetable glycerin.

In various embodiments of the method, emitting the light from the light source includes emitting the light without precise temperature control.

In various embodiments of the method, emitting the light from the light source includes emitting light having a plurality of wavelengths that include the predetermined wavelength, wherein the plurality of wavelengths account for temperature changes due to lack of precise temperature control.

In various embodiments of the method, detecting light resulting from the emitted light includes detecting light in a wavelength band that includes the predetermined wavelength.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

A better understanding of the features and advantages of the disclosed technology will be obtained by reference to the following detailed description that sets forth illustrative embodiments, in which the principles of the technology are utilized, and the accompanying drawings of which:

FIG. 1 is a block diagram of an exemplary vape detection system, provided in accordance with aspects of the present disclosure;

FIG. 2 is a block diagram of an exemplary vape detection sensor, in accordance with aspects of the present disclosure;

FIG. 3 is a diagram of an exemplary vape detection environment utilizing optical vape detection, in accordance with aspects of the present disclosure;

FIG. 4 is a flow diagram of an exemplary operation of detecting vape, in accordance with aspects of the present disclosure; and

FIG. 5 is an exemplary chart diagram illustrating absorbance of various infrared wavelengths by propylene glycol, in accordance with aspects of the present disclosure.

### DETAILED DESCRIPTION

Embodiments of the presently disclosed vape detection system are described in detail with reference to the drawings, in which like reference numerals designate identical or corresponding elements in each of the several figures.

The present disclosure is generally directed to a vape detection system configured to detect the presence of vape based on optical characteristics of vape in the air. When vaping is identified at a location, warnings or alerts may be communicated to registered users or clients without providing any indication of warnings to the person who vaped or is vaping at the location. In this way, the person(s) who are vaping can be timely intercepted. Aspects of vape detection are described in International Patent Application Publication No. WO2019035950A1, which is hereby incorporated by reference herein in its entirety. The particular illustrations and embodiments disclosed herein are merely exemplary and do not limit the scope or applicability of the disclosed technology.

Aspects of the present disclosure relate to absorption spectroscopy, which is the investigation and measurement of absorption of radiation, as a function of frequency or wavelength, due to its interaction with a sample, such as investigation and measurement of different materials absorbing energy differently across the electromagnetic spectrum. The amount of absorption at one or more wavelengths is based on the concentration of particular materials, e.g., the number of particles of a constituent of vape. Traditional absorption spectroscopy systems include precise and/or dedicated temperature control because temperature changes vary the wavelength of light emitted by a light source, so even a slight change in temperature affects measurement readings. Therefore, traditional absorption spectroscopy systems include a dedicated heater and/or cooler to precisely control temperature. In contrast, embodiments of the present disclosure may not include such dedicated and/or precise temperature control. Rather, in accordance with aspects of the present disclosure, crude temperature control can be used to bring laser temperature within a workable range. In various embodiments, crude temperature control can be implemented by components which generate or absorb heat but which are not dedicated to controlling temperature. Additionally or alternatively, a light source can emit light having a plurality of wavelengths to account for temperature changes due to lack of precise and/or dedicated temperature control. However, aspects of the present disclosure can operate with precise and/or dedicated temperature control as well.

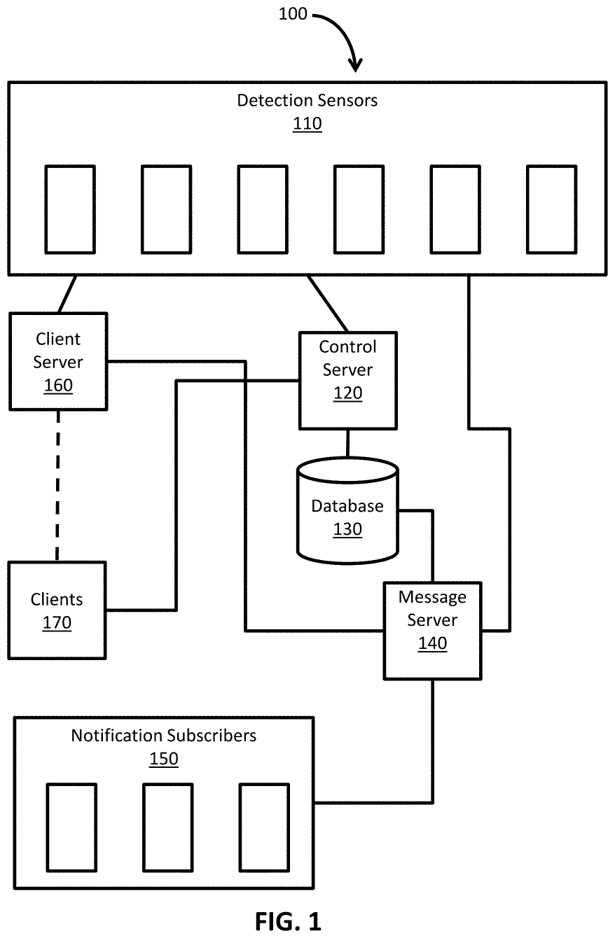

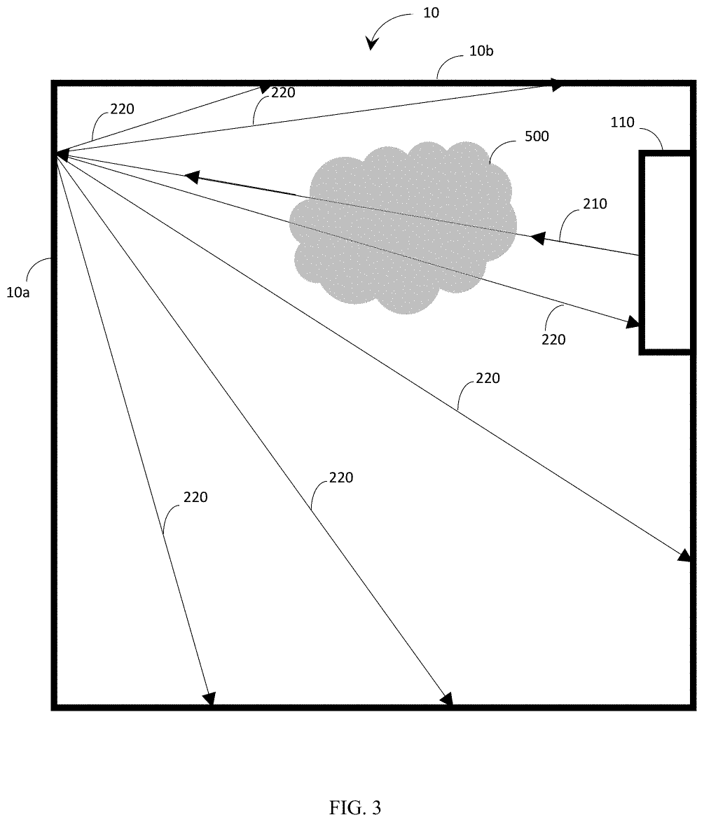

Referring now to FIG. 1, there is shown a block diagram of an exemplary detection system 100. The illustrated detection system 100 includes one or more detection sensors 110 which are configured to detect vaping characteristics in the air, a control server 120, and a database 130 storing data. The detection sensors 110 will be described in more detail in connection with FIG. 3. For now, it is sufficient to note that the detection sensors 110 utilize optical technology to emit and detect light having particular wavelengths, which are targeted to vape characteristics in the air. As used herein, the term “light” includes visible light as well as non-visible light in the infrared or ultraviolet spectrum. In aspects of the present disclosure, the infrared spectrum is used by the detection sensors 110 to emit and detect light having infrared wavelengths, which persons skilled in the art will recognize. For example, in various embodiments, the infrared spectrum can include wavelengths of 0.7 μm-1 mm. In various embodiments, the detected data of the detection sensors 110 may be processed by the detection sensors 110 and/or may be processed by the control server 120. In various embodiments, each detection sensor 110 can include circuitry for independently operating itself. In various embodiments, the control server 120 can control certain aspects of the detection sensors 110. The control server 120 may communicate with the detection sensors 110 using an application programming interface (“API”).

In various embodiments, the control server 120 may control the detection sensors 110 collectively, individually, and/or in groups. For example, in the case where several detection sensors 110 may be installed at the same general location, such as several sensors in a single bathroom, the control server 120 may control such detection sensors 110 collectively. As another example, in the case where several detection sensors 110 are installed at different locations of a site, such as sensors installed in several bathrooms, the control server 120 may control such detection sensors 110 individually or in groups because detection sensors 110 in different locations may experience different conditions.

In accordance with aspects of the present disclosure, the detection sensors 110 may have a learning mode and an active mode. In various embodiments, the learning mode may be used to collect data when there is no vape in the air and, in that manner, generate baseline data from the detection sensors 110 in the absence of vape. The baseline data reflects environmental conditions of the locations where the detection sensors 110 are located, and the use of baseline data can improve accuracy of the vape detection operations. For example, in various embodiments, the detection sensors 110 may have internal parameters which can be adjusted based on the baseline data. In various embodiments, the detection sensors 110 and/or the control server 120 can set a threshold value for vape detection based on the baseline data. The threshold value can be used in the active mode of the detection sensors 110 to detect vaping based on comparing detected data to the threshold value. In various embodiments, the detection sensors 110 and/or the control server 120 may enable learning mode at various times of a day to set different thresholds tailored to environmental conditions at different times of a day.

In an aspect of the present disclosure, and as described in more detail below in connection with FIG. 3, vape includes constituents which absorb particular wavelengths, such that vaping may be detected based on absorption spectroscopy. In various embodiments, a detection system 100 can use one or more of baseline data, threshold values, and/or absorption spectroscopy to detect vaping, and any such data or values can be stored in the database 130. The control server 120 may use a query language to communicate with the database 130. The query language may be SQL, MySQL, SSP, C, C++, C#, PHP, SAP, Sybase, Java, JavaScript, or another language which can be used to communicate with a database.

With continuing reference to FIG. 1, the illustrated detection system 100 includes a message server 140, notification subscribers 510, a client server 160, and clients 170. In various embodiments, the notification subscribers 150 may be persons who do not have direct access to the control server 120, and the clients 170 may be persons who have direct access to the control server 120. The clients 170 are persons who are responsible for the locations where the detection sensors 110 are installed. For example, the clients 170 may include a principal, vice president, or person in charge at a school, a president at a company, a manager at a hospital or any commercial establishment, or security personnel. This list, however, is exemplary and is not intended to be exhaustive. Other persons having different positions can be included in this list. Communication between the clients 170 and the control server 120 may utilize http, https, ftp, SMTP, or other Internet protocols. In various embodiments, the clients 170 may be able to direct the control server 120 to adjust settings for various detection sensors 110. In various embodiments, clients 170 may log-in to the control server 120 to view reports or graphical representations of detection results from the detection sensors 110.

The message server 140 sends alerts to the notification subscribers 150 via a text message, email, instant message, telephone call, audible warning, and/or another type of electronic communication. The notification subscribers 150 may receive the alerts via a computer, smart device, mobile phone, personal digital assistant, tablet, and/or another type of electronic device. The contact information for the notification subscribers 150 can be stored in the database 130, and the message server 140 can access such contact information from the database 130. In various embodiments, the client server 160 may communicate with the message server 140 to instruct the message server 140 to notify the notification subscribers 150. In various embodiments, the detection sensors 110 can directly instruct the message server 140 to notify the notification subscribers 150. In various embodiments, the control server 120 can instruct the message server 140 to notify the notification subscribers 150. These embodiments are exemplary, and other variations are contemplated to be within the scope of the present disclosure.

In various embodiments, where the detection sensors 110 are configured to detect vaping, the detection sensors 110 may send an alert to the client server 160 using Internet protocols. The client server 160 can communicate a text message, an email, and/or an app notification to the clients 170 associated with the location where the vaping was detected. In FIG. 1, the connection between the client server 160 and the clients 170 is shown as a dotted line to indicate that communications depend on client connectivity such that communications may not timely reach the clients 170 if the clients 170 have poor telecommunication connectivity. In various embodiments, the client server 160 can provide an interface, such as an app interface or a web page interface, for registering and updating information for the clients 170, such as contact information and associations of particular clients with particular locations.

In an aspect of the present disclosure, the database 130 can include historical data, such as data indicating time and location of vape detections. The control server 120 may analyze the historical data to predict future occurrences of vaping at particular locations and times, so that appropriate or precautionary measures may be taken. In various embodiments, the control server 120 may analyze the historical data stored at the database 130 to identify trends, such as a decreasing or increasing pattern of occurrences of detected vaping.

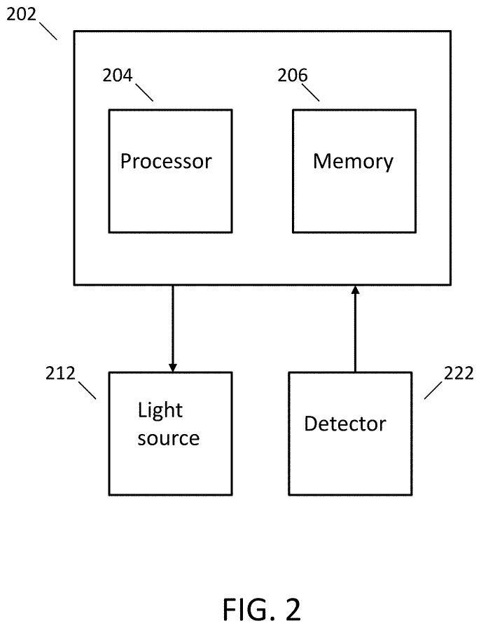

Referring now to FIG. 2, an exemplary detection sensor is provided in accordance with aspects of the present disclosure. The detection sensor includes a controller 202, a light source 212, and a detector 222. The detection sensor is described herein as an optical vape detector for detecting the presence of vape, but other applications are also contemplated. The following will describe detection of vape, but it is intended that the detection sensor can generally be used for detecting presence of a substance based on constituents of the substance. In various embodiments, the light source 212 and detector 222 may be integrated with another device/equipment or can be a stand-alone device.

The controller 202 includes a processor 204 and a memory 206. The processor 204 can be any programmable device that executes machine instructions, such as one or more of a central processing unit, microcontroller, digital signal processor, graphics processing unit, field programmable gate array, and/or programmable logic device, among others. The memory 206 can include volatile memory, such as random access memory, and/or non-volatile memory, such as flash memory and/or magnetic storage. The memory 206 stores information relating to constituents of vape and/or the respective wavelengths that are absorbed by the constituents of vape, such as, for example, the ingredients in vape liquid and the components in vape smoke/vapor. The memory also stores machine/software instructions which can be executed by the processor 204. The processor 204 executes the machine/software instructions to carry out the processing and computations, which will be described in more detail later herein.

With continued reference to FIG. 2, the light source 212 is communicatively coupled to the controller 202. In various embodiments, the light source 212 may be a broadband light source or may be a narrow-band light source, such as a monochromator or tunable laser. In various embodiments, the light source(s) can be designed to enable absorption spectroscopy capabilities covering particular wavelength regions.

In various embodiments, the light source 212 is configured to emit one or more laser beams or emit light that includes one or more predetermined wavelengths. In various embodiments, the predetermined wavelengths may be any wavelength that is absorbed to some degree by the constituents of vape, such as, for example, propylene glycol, vegetable glycerin, nicotine, vitamin E acetate, and/or ingredients used for flavorings that appear in vape smoke/vapor. The light source 212 may emit light using absorption spectroscopy techniques. For example, the light source 212 may modulate the wavelength of the emitted light in accordance with absorption spectroscopy techniques. In various embodiments, the light source 212 can be configured to emit modulated light that includes the one or more predetermined wavelengths of interest, which are absorbed to some degree by the constituents of vape. As mentioned above, in various embodiments, the detection system does not include precise and/or dedicated temperature control such that the wavelengths emitted by the light source 212 may drift as the temperature changes beyond the tolerance levels of typical absorption spectroscopy applications. For example, the light source 212 and/or other components generate heat, which can increase the temperature of the light source 212 and cause the emitted wavelengths to drift. In accordance with aspects of the present disclosure, and in view of wavelength drift, the light source 212 can be configured to modulate the emitted light across a range of wavelengths that accounts for temperature changes, such that a portion of the emitted light would include the one or more wavelengths of interest. In various embodiments, the detection system may include two or more light sources that cooperate to emit light. In various embodiments, the light source(s) 212 may be configured to emit multiple light beam(s) to cover some or all constituents of vape. In various embodiments, even though the detection system does not include precise and/or dedicated temperature control, the detection system can include a crude and/or non-dedicated heating mechanism that enables a form of imprecise temperature control. For example, heating caused by operation of the light source 212 and/or of other components, such as a resistor, can function as a non-dedicated and/or crude heating source that can bring the temperature into a workable operating range.

With continued reference to FIG. 2, the detector 222 is communicatively coupled to the controller 202. The detector 222 is configured to sense light or other electromagnetic radiation of the light resulting from the light beam emitted from the light source 212. In various embodiments, the detector 222 may be a photodetector. In various embodiments, the detector 222 may include a filter which diffracts light into multiple wavelengths. In various embodiments, the data provided by the detector 222 may be used by the controller 202 to determine various measures relating to the environment of the detection sensor, such as absorption spectroscopy measures (e.g., wavelength modulation distortion, among others). In various embodiments, the controller 202 may process the detector data based on absorption spectroscopy techniques to determine presence of a constituent of a substance. For example, the detector data may include detection of light in a wavelength band that includes the one or more predetermined wavelengths which are absorbable by a constituent of vape, and in a band that is large enough to account for drift due to temperature changes. If modulation characteristics of the detected light differ from modulation characteristics of the emitted light, the controller 202 can determine that a constituent of the target substance is present. The wavelength modulation technique is exemplary. In various embodiments, other absorption spectroscopy measures and techniques can be used. In various embodiments, the detection sensor may include two or more detectors(s) 222 that cooperate to measure various light wavelengths or wavelength bands. In various embodiments, the detection sensor may include a detector 222 configured to measure multiple wavelengths, such as a wavelength band that includes one or more wavelengths in the light emitted by the light source 212.

In various embodiments, and referring again to FIG. 1, a detection sensor (110, FIG. 1) can include components which are not specifically illustrated, such as a network interface device which enables communication with other devices wirelessly or via a wired connection. A wireless connection may utilize a wide area network (WAN), local area network (LAN), personal area network (PAN), ad hoc network, and/or cellular network, among other networks. A wired connection may utilize category 5 cable Ethernet (CATS), CAT5E cable, category 6 Ethernet cable (CAT6), or other network cables. The detection sensor 110 can include a wall-mounted housing and the components of the detection sensor 110 may be contained in the wall-mounted housing, including the light source 212 and the detector 222. In various embodiments, the detection sensor 110 can include a ceiling-mounted housing and the components of the detection sensor 110 may be contained in the ceiling-mounted housing.

In various embodiments, a detection sensor 110 can include batteries to power the detection sensor 110, such as AA, AAA, or other suitable batteries. In various embodiments, a detection sensor 110 can include a connection to a power outlet to receive power from a power grid. In various embodiments, a detection sensor 110 may receive power supplied through a network cable based on standards such as, without limitation, Power-over-Ethernet (PoE), PoE+, or 4PPoE.

With reference to FIG. 3, there is shown a diagram of utilizing a wall-mounted exemplary vape detection sensor. The vape detection sensor 110 may be placed in an environment 10, such as an enclosed area. The light source of the vape detection sensor 110 emits a light beam 210 that includes one or more predetermined wavelengths which are absorbable by constituents of vape smoke/vapor. The emitted light beam 210 is reflected and/or scattered off of various surfaces, e.g., walls 10a and/or ceilings 10b of the environment 10, resulting in reflected and/or scattered light 220. In the event that vape smoke/vapor 500 is present, emitted light beam 210 or reflected/scattered light 220 may intersect the vape smoke/vapor 500 and maybe be partially or wholly absorbed by the vape smoke/vapor 500. The detector of the vape detection sensor 110 receives at least a portion of the reflected/scattered light 220 and measures the received light over a wavelength band that includes the predetermined wavelengths contained in the light beam 210 that was emitted. The vape detection sensor 110 can determine whether vape smoke/vapor 500 is present based on comparing the emitted light beam 210 and the reflected/scattered light received at the detection sensor 110 based on absorption spectroscopy techniques, such as wavelength modulation distortion, among others.

As described above, the detection sensor 110 can include a learning mode and an active mode. With continued reference to FIG. 3, the learning mode operates in the absence of vape smoke/vapor 500 to provide baseline data for the environment 10. The baseline data may establish, for example, the level/degree of reflected/scattered light that the detection sensor 110 can expect to receive without any vape smoke/vapor, among other things. Then, a threshold value can be established that is different from the baseline data, such that any detection level that is greater than or less than the threshold value would correspond to presence of vape smoke/vapor.

In various embodiments, vape detection can be implemented based on ranges of acceptable values, which can be configured to account for noise, such as, for example dark current, shot noise, readout noise, stray light, and electronic noise. A range of acceptable values may or may not be adjusted based on learning mode baseline data.

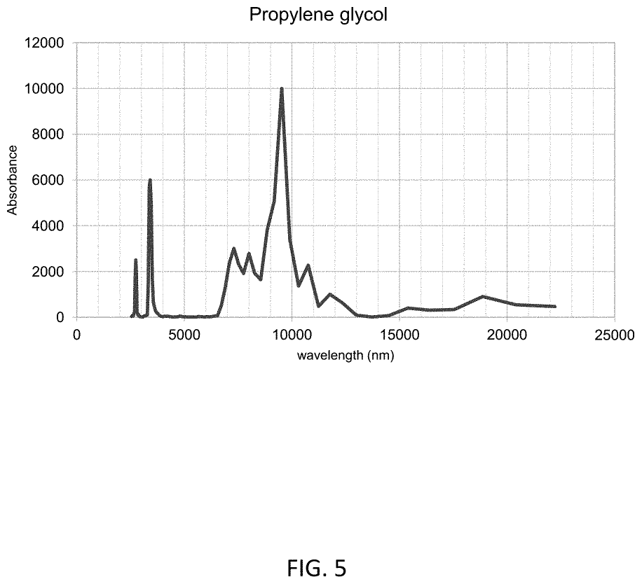

In various embodiments, and as described above, vaping may have characteristics in terms of which wavelengths of light are absorbed and the degree of absorption of particular wavelengths, as different wavelengths may be absorbed in different ways by the constituents of vape smoke/vapor. FIG. 5 shows an example of an absorbance of particular wavelengths by propylene glycol, which is a constituent of vape smoke/vapor. In various embodiments, vape may be detected using absorption spectroscopy techniques with respect to absorbance of particular wavelengths by constituents of vape. As an example, a specific wavelength such as 9523.8 nm may be used to detect vape smoke/vapor based on its constituent propylene glycol, due to propylene glycol having high absorbance for the wavelength 9523.8 nm in the infrared spectrum, as shown in FIG. 5. Accordingly, absorption spectroscopy techniques can be used in relation to the specific wavelength(s) absorbed by constituents of vape to detect presence of vape.

When vape is detected, an alert is triggered by the vape detection system, and the alert may be sent to notification subscribers 150 or to clients 170, as shown in FIG. 1, via text message, email, instant message, telephone call, audible warning, or other types of electronic communication. The illustrated embodiment of FIG. 3 is exemplary and variations are contemplated to be within the scope of the present disclosure. For example, in various embodiments, the detection sensor 110 can be a ceiling-mounted sensor. In various embodiments, a ceiling-mounted sensor can be mounted at or near an edge of the ceiling to have coverage of an entire room.

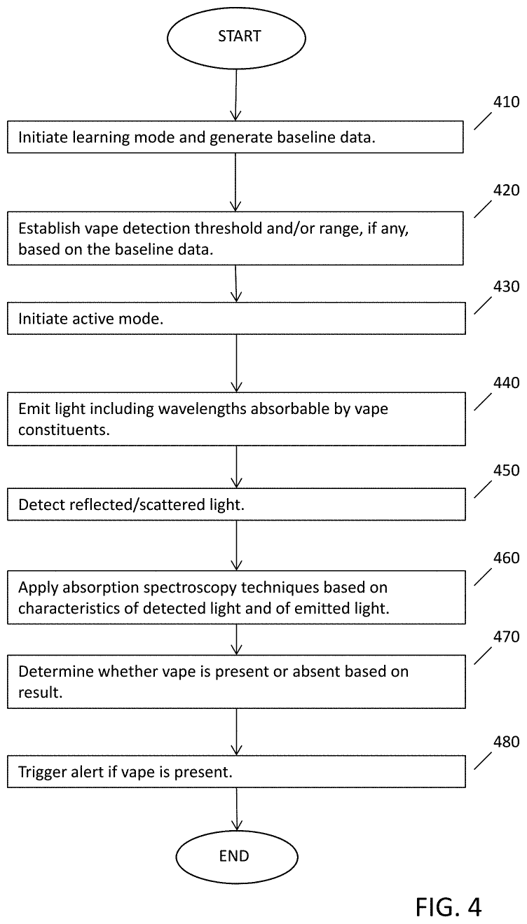

Referring now to FIG. 4, there is shown an exemplary vape detection operation. At block 410, the operation initiates learning mode and generates baseline data. At block 420, the operation establishes one or more vape detection thresholds and/or ranges, if any, based on the baseline data. At block 430, active detection of vaping is initiated. At block 440, the operation emits light from a light source that includes predetermined wavelength which are absorbable by constituents of vape. As described above, the emitted light reflects and/or scatters in the environment. At block 450, the operation detects at least a portion of the reflected/scattered light. At block 460, the operation applies absorption spectroscopy techniques based on characteristics of detected light and of emitted light. At block 470, the operation determines whether vape is present or absent based on the result. At block 480, the operation triggers an alert if vape is determined to be present. The operation of FIG. 4 is exemplary, and variations are contemplated to be within the scope of the present disclosure. For example, in various embodiments, the operation may not include a learning mode and may not include blocks 410, 420. Rather, thresholds and/or ranges may be predetermined or may not be used, such that the operation begins in active mode. In various embodiments, after the learning mode of blocks 410, 420 are performed, the active mode blocks 430-480 can be repeated without performing learning mode again for some time. In various embodiments, various blocks of the illustrated operation may be performed by different devices. For example, blocks 410-450 may be performed by a detection sensor and blocks 460-480 may be performed by a control server. In various embodiments, the entire operation of FIG. 4 can be performed by a detection sensor. Other variations are contemplated to be within the scope of the present disclosure.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A vape detection system, comprising:
a light source configured to emit light, the light including a predetermined wavelength that is absorbable by a constituent of vape;
a detector configured to detect light resulting from the emitted light; and
a controller in communication with the light source and the detector, the controller configured to:
control the light source to emit the light including the predetermined wavelength,
control the detector to detect light resulting from the emitted light, and
determine, based on absorption spectroscopy and based on a change between the emitted light and the detected light, that the constituent of vape is present.

2. The vape detection system according to claim 1, wherein the light source is a tunable narrow band laser.

3. The vape detection system according to claim 1, wherein the detector is a photodetector.

4. The vape detection system according to claim 1, further comprising a wall-mounted housing, wherein the light source and the detector are contained in the wall-mounted housing.

5. The vape detection system according to claim 1, wherein the constituent of vape includes at least one of propylene glycol or vegetable glycerin,
wherein the predetermined wavelength is absorbable by at least one of the propylene glycol or the vegetable glycerin.

6. The vape detection system according to claim 1, wherein the light source emits the light without precise temperature control, and wherein the controller controls the light source without precise temperature control.

7. The vape detection system according to claim 6, wherein the light source is configured to emit the light having a plurality of wavelengths that include the predetermined wavelength, wherein the plurality of wavelengths account for temperature changes due to lack of precise temperature control.

8. The vape detection system according to claim 7, wherein the detector is configured to detect a wavelength band that includes the predetermined wavelength.

9. A method of detecting vape, the method comprising:
emitting, from a light source, light including a predetermined wavelength that is absorbable by a constituent of vape;
detecting, by a detector, light resulting from the emitted light; and
determining, based on absorption spectroscopy and based on a change between the emitted light and the detected light, that the constituent of vape is present.

10. The method according to claim 9, wherein the light source is a tunable narrow band laser.

11. The method according to claim 9, wherein the detector is a photodetector.

12. The method according to claim 9, wherein the light source and the detector are contained in a wall-mounted housing.

13. The method according to claim 9, wherein the constituent of vape includes at least propylene glycol or vegetable glycerin,
wherein the predetermined wavelength is absorbable by at least one of the propylene glycol or vegetable glycerin.

14. The method according to claim 9, wherein emitting the light from the light source includes emitting the light without precise temperature control.

15. The method according to claim 14, wherein emitting the light from the light source includes emitting light having a plurality of wavelengths that include the predetermined wavelength, wherein the plurality of wavelengths account for temperature changes due to lack of precise temperature control.

16. The method according to claim 15, wherein detecting light resulting from the emitted light includes detecting light in a wavelength band that includes the predetermined wavelength.
